(19) United States
(12) Patent Application Publication
(10) Pub. No.: US 2009/0012826 A1
(43) Pub. Date: Jan. 8, 2009

(54) METHOD AND APPARATUS FOR ADAPTIVE INTERACTION ANALYTICS

(75) Inventors: Barak EILAM, Raanana (IL); Yuval LUBOWICH, Raanana (IL); Oren PEREG, Zikhron Ya'akov (IL); Oren LEWKOWICZ, Tzur Moshe (IL)

Correspondence Address: OHLANDT, GREELEY, RUGGIERO & PERLE, LLP, ONE LANDMARK SQUARE, 10TH FLOOR, STAMFORD, CT, 06901, US

(73) Assignee: NICE SYSTEMS LTD., Raanana (IL)

(21) Appl. No.: 11/772,258

(22) Filed: Jul. 2, 2007

(51) Int. Cl. G06Q 10/00

(52) U.S. Cl. 705/7

(57) ABSTRACT

A method and apparatus for revealing business or organizational aspects of an organization from interactions, broadcasts or other sources. The method and apparatus classify the interactions into predefined categories. Then additional processing is performed on interactions in one or more categories, and analysis is executed for revealing insights, trends, problems, causes for problems, and other characteristics within the one or more categories.

### BACKGROUND

1. Field of the Invention

The present invention relates to interaction analysis in general and to retrieving insight and trends from categorized interactions in particular.

2. Discussion of the Related Art

Within organizations or organizations' units that handle interactions with customers, suppliers, employees, colleagues or the like, it is often required to extract information from the interactions in an automated and efficient manner. The organization can be for example a call center, a customer relations center, a trade floor, a law enforcements agency, a homeland security office, or the like. The interactions may be of various types, including phone calls using all types of phone systems, recorded audio events, walk-in center events, video conferences, e-mails, chats, captured web sessions, captured screen activity sessions, instant messaging, access through a web site, audio segments downloaded from the internet, audio files or streams, the audio part of video files or streams or the like.

The interactions received or handled by an organization constitute a rich source of customer related information, product-related information, or any other type of information which is significant for the organization. However, retrieving the information in an efficient manner is typically a problem. A call center or another organization unit handling interactions receives a large amount of interactions, mainly depending on the number of employed agents. Listening, reading or otherwise relating to a significant percentage of the interactions would require time and manpower of the same order of magnitude that was required for the initial handling of the interaction, which is apparently impractical. In order to extract useful information from the interactions, the interactions are preferably classified into one or more hierarchical category structure, wherein each hierarchy consists of one or more categories. The hierarchies and the categories within each hierarchy may be disjoint, partly or filly overlap, contain each other, or the like. However, solely classifying the interactions into categories may not yield practical information. For example, categorizing the interactions incoming into a commercial call center into “content customers” and “disappointed customers” would not assist the organization in understanding why customers are unhappy or what can be done to improve the situation.

There is therefore a need in the art for a system and method for extracting information from categorized interactions in an efficient manner. The method and apparatus should be efficient so as to handle large volumes of interactions, and to be versatile to be used by organizations of commercial or any other nature, and for interactions of multiple types, including audio interactions, textual interactions or the like.

### SUMMARY

The disclosed method and apparatus provide for revealing business or organizational aspects of an organization from interactions, broadcasts or other sources. The method and apparatus classify the interactions into predefined categories. Then additional processing is performed on interactions within one or more categories, and analysis is executed for revealing insights, trends, problems, and other characteristics within such categories.

In accordance with the disclosure, there is thus provided a method for detecting one or more aspects related to an organization from one or more captured interactions, the method comprising the steps of receiving the captured interactions, classifying the captured interactions into one or more predefined categories, according to whether the each interaction complies with one or more criteria associated with each category; performing additional processing on the at captured interaction assigned to the categories to extract further data; and analyzing one or more results of performing the additional processing or of the classifying, to detect the one or more aspects. The method can further comprise a category definition step for defining the categories and the criteria associated with the categories. Alternatively, the method can further comprise a category receiving step for receiving the categories and the criteria associated with the categories. Optionally, the method comprises a presentation step for presenting to a user the aspects. Within the method, the presentation step can relate to presentation selected from the group consisting of: a graphic presentation; a textual presentation; a table-like presentation; a presentation using a third party tool; and a presentation using a third party portal. The method optionally comprises a preprocessing step for enhancing the captured interactions. Optionally, the method further comprises a step of capturing or receiving additional data related to the captured interactions. The additional data is optionally selected from the group consisting of: Computer Telephony Integration data; Customer Relationship Management data; billing data; screen event; a web session event; a document; and demographic data. Within the method, the categorization or the additional processing steps include activating one or more engines from the group consisting of: word spotting engine; phonetic search engine; transcription engine; emotion analysis engine; call flow analysis engine; web activity analysis engine; and textual analysis engine. Within the method, the analyzing step optionally includes activating one or more engines from the group consisting of: data mining; text mining; root cause analysis; link analysis; contextual analysis; text clustering, pattern recognition; hidden pattern recognition; a prediction algorithm; and OLAP cube analysis. Within the method, any of the captured interactions is optionally selected from the group consisting of: a phone conversation; a voice over IP conversation; a message; a walk-in center recording; a microphone recording; an audio part of a video recording; an e-mail message; a chat session; a captured web session; a captured screen activity session; and a text file. The predefined category can be parts of a hierarchical category structure. Within the method, each of the criteria optionally relates to the captured interactions or to the additional data.

Another aspect of the disclosure relates to a computing platform for detecting one or more aspects related to an organization from one or more captured interactions, the computing platform executing: a categorization component for classifying the captured interactions into one or more predefined categories, according to whether each interaction complies with one or more criteria associated with each category; an additional processing component for performing additional processing on the captured interactions assigned to the at least one of the predetermined categories to extract further data; and a modeling and analysis component for analyzing the further data or results produced by the classification component, to detect the aspects. The computing platform can further comprise a category definition component for defining the categories, and the criteria associated with each category. Optionally, the computing platform comprises a presentation component for presenting the aspects. The presentation component optionally enables to present the aspects in a manner selected from the group consisting of: a graphic presentation; a textual presentation; a table-like presentation; and a presentation using a third party tool or portal. The computing platform optionally comprises a logging or capturing component for logging or capturing the captured interactions. The computing platform can further comprise a logging or capturing component for logging or capturing additional data related to the captured interactions. Within the computing platform, the additional data is optionally selected from the group consisting of: Computer Telephony Integration data; Customer Relationship Management data; billing data; screen event; a web session event; a document; and demographic data. Within the computing platform, the categorization component or the additional processing component optionally include activating one or more engines from the group consisting of: word spotting engine; phonetic search engine; transcription engine; emotion analysis engine; call flow analysis engine; web activity analysis engine; and textual analysis. Within the computing platform, the modeling and analysis component optionally activates one or more engines from the group consisting of: data mining; text mining; root cause analysis; link analysis; contextual analysis; text clustering, pattern recognition; hidden pattern recognition; a prediction algorithm; and OLAP cube analysis. Within the computing platform, the captured interactions are optionally selected from the group consisting of: a phone conversation; a voice over IP conversation; a message; a walk-in center recording; a microphone recording; an audio part of a video recording; an e-mail message; a chat session; a captured web session; a captured screen activity session; and a text file. The computing platform can firer comprise a storage device for storing the categories, or the at least one criteria, or the categorization. The computing platform can further comprise a quality monitoring component for monitoring one or more quality parameters associated with the captured interactions.

### BRIEF DESCRIPTION OF TIE DRAWINGS

The present invention will be understood and appreciated more fully from the following detailed description taken in conjunction with the drawings in which corresponding or like numerals or characters indicate corresponding or like components. In the drawings:

FIG. 1 is a block diagram of the main components in a typical environment in which the disclosed method and apparatus are used;

FIG. 2 is an exemplary screenshot showing aspects detected by preferred embodiments of the disclosed method and apparatus;

FIG. 3 is a block diagram of the main components in a preferred embodiment of the disclosed apparatus; and

FIG. 4 is a flowchart of the main steps in a preferred embodiment of the disclosed method.

### DETAILED DESCRIPTION

The disclosed subject matter provides a method and apparatus for extracting and presenting information, such as reasoning, insights, or other aspects related to an organization from interactions received or handled by the organization.

In accordance with a preferred embodiment of the disclosed subject matter, interactions are captured and optionally logged in an interaction-rich organization or organizational unit. The organization can be for example a call center, a trade floor, a service center, an emergency center, a lawfill interception, or any other location that receives and handles a multiplicity of interactions. The interactions can be of any type, such as vocal interactions including for example phone calls, audio parts of video interactions, microphone-captured interactions and others, e-mails, chats, web sessions, screen events sessions, faxes, and any other interaction type. The interactions can be between any two parties, such as a member of the organization for example an agent, and a customer, a client, an associate or the like. Alternatively the interactions can be intra-organization, for example between a service-providing department and other departments, or between two entities unrelated to the organization, such as an interaction between two targets captured in a lawful interception center. The user, such as an administrator, a content expert or the like defines categories and criteria for an interaction to be classified into each category. Alternatively, categories can be received from an external source, or defined upon a statistical model or by an automatic tool. Further, the categorization of a corpus of interactions can be received, and criteria for interactions can be deduced, for example by neural networks. Each interaction is matched using initial analysis against some or all the criteria associated with the categories. The interaction is assigned to one or more categories whose criteria are matched by the interaction. The categories can relate to different products, to customer satisfaction levels, to problem reported or the like. Further, each interaction can be tested against multiple categorizations. For example, an interaction can be assigned to a category related to “unhappy customers, to a category related to “product X”, and to a category related to “technical problems”. The categorization is preferably performed by efficient processing in order to categorize as many interactions as possible.

After the initial analysis and classification, the interactions in one or more categories are further processed by targeted analysis. For example, it may be reasonable for a business with limited resources to further analyze interactions assigned to an “unhappy customer” category and not to analyze the “content customer category”. In another example, the company may prefer to further analyze categories related to new products over analyzing other categories.

The analysis of the interactions in a category is preferably targeted, i.e. consists of analysis types that match the interactions. For example, emotion analysis is more likely to be performed on interactions related to an “unhappy customer” category than on interactions related to “technical problems” category. The products of the targeted analysis are preferably stored, in a storage device.

Preferably, the initial analysis used for classification uses fast algorithms, such as phonetic search, emotion analysis, word spotting, call flow analysis, i.e., analyzing the silence periods, cross over periods, number and length of hold periods, number of transfers or the like, web flow analysis, i.e. tracking the activity of one or more users in a web site and analyzing their activities, or others. The advanced analysis optionally uses more resource-consuming analysis, such as speech-to-text, intensive audio analysis algorithms, data mining, text mining, root cause analysis being analysis aimed at revealing the reason or the cause for a problem or an event from a collection of interactions, link analysis, being a process that finds related concepts related to the target concept such as a word or a phrase, contextual analysis which is a process that extracts sentences that include a target concept out of texts, text clustering, pattern recognition, hidden pattern recognition, a prediction algorithm, OLAP cube analysis, or others. Third party engines, such as Enterprise Miner™ manufactured by SAS (www.sas.com), can be used as well for advanced analysis. Both the initial analysis and the advanced analysis may use data from external sources, including Computer-Telephony-Integration (CTI) information, billing information, Customer-Relationship-Management (CRM) data, demographic data related to the participants, or the like.

Once the further analysis is done, optionally modeling is farther performed on the results. The modeling preferably includes analysis of the data of the initial analysis upon which the interaction was classified, and the advanced analysis. The advanced extraction may include root cause analysis, data mining, clustering, modeling, topic extraction, context analysis or other processing, which preferably involves two or more information types gathered during the initial analysis or the advanced analysis. The advanced extraction may further include link analysis, relating to extracting phrases that have a high co-appearance frequency within one or more analyzed phrases, paragraphs or other segments.

The results of the initial analysis, advanced analysis and modeling are presented to a user in one or more ways, including graphic representation, table representation, textual representation, issued alarms or alerts, or the like. The results can be further fed back and change or affect the classification criteria, the advanced analysis, or the modeling techniques.

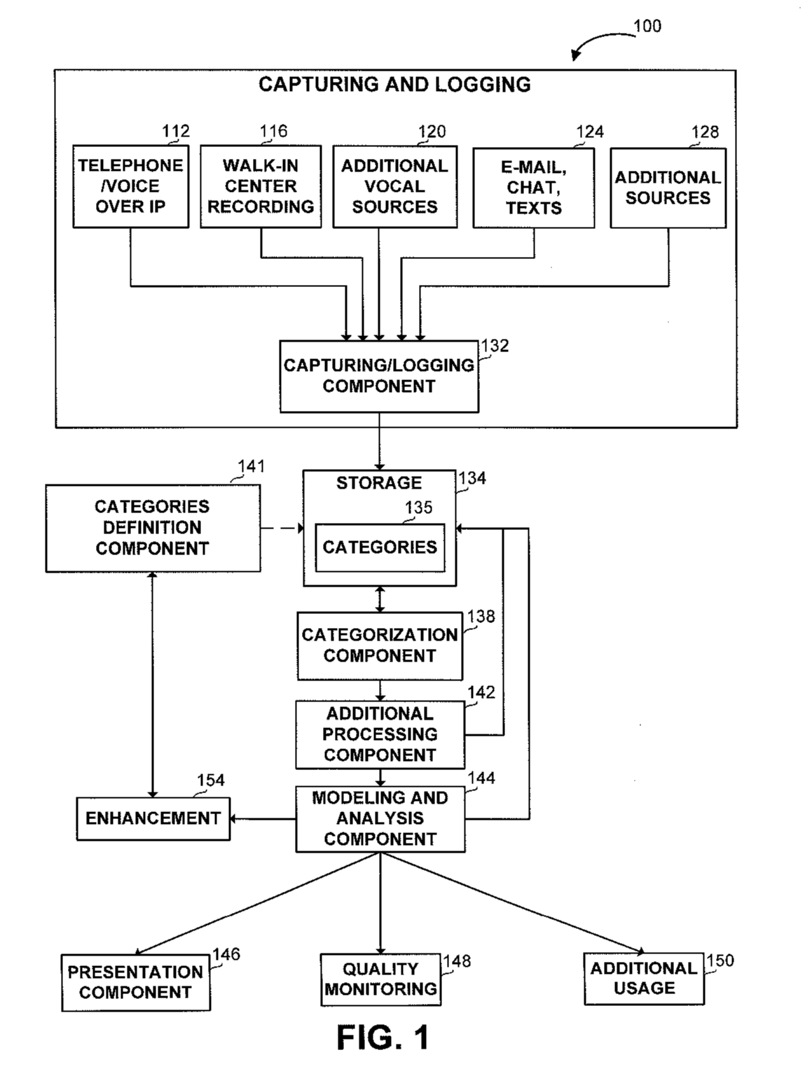

Referring now to FIG. 1, showing a block diagram of the main components in a typical environment in which the disclosed invention is used. The environment, generally referenced 100, is an interaction-rich organization, typically a call center, a bank, a trading floor, an insurance company or another financial institute, a public safety contact center, an interception center of a law enforcement organization, a service provider, an internet content delivery company with multimedia search needs or content delivery programs, or the like. Segments, including broadcasts, interactions with customers, users, organization members, suppliers or other parties are captured, thus generating input information of various types. The information types optionally include auditory segments, non-auditory segments and additional data. The capturing of voice interactions, or the vocal part of other interactions, such as video, can employ many forms and technologies, including trunk side, extension side, summed audio, separate audio, various encoding and decoding protocols such as G729, G726, G723.1, and the like. The vocal interactions usually include telephone or voice over IP sessions 112. Telephone of any kind, including landline, mobile, satellite phone or others is currently the main channel for communicating with users, colleagues, suppliers, customers and others in many organizations. The voice typically passes through a PABX (not shown), which in addition to the voice of two or more sides participating in the interaction collects additional information discussed below. A typical environment can further comprise voice over IP channels, which possibly pass through a voice over IP server (not shown). It will be appreciated that voice messages are captured and processed as well, and that the handling is not limited to two- or more sided conversation. The interactions can further include face-to-face interactions, such as those recorded in a walk-in-center 116, and additional sources of vocal data 120, such as microphone, intercom, the audio part of video capturing, vocal input by external systems, broadcasts, files, or any other source. In addition, the environment comprises additional non-vocal data Apes such as e-mail, chat, web session, screen event session, internet downloaded content, text files or the like 124. In addition, data of any other type 128 is received or captured, and possibly logged. The information may be captured from Computer Telephony Integration (CTI) equipment used in capturing the telephone calls and can provide data such as number and length of hold periods, transfer events, number called, number called from, DNIS, VDN, ANI, or the like. Additional data can arrive from external or third party sources such as billing, Customer-Relationship-Management (CRM), screen events including text entered by a call representative during or following the interaction, web session events and activity captured on a web site, documents, demographic data, and the like. The data can include links to additional segments in which one of the speakers in the current interaction participated. Data from all the above-mentioned sources and others is captured and preferably logged by capturing/logging component 132. Capturing/logging component 132 comprises a computing platform running one or more computer applications as is detailed below. The captured data is optionally stored in storage 134 which is preferably a mass storage device, for example an optical storage device such as a CD, a DVD, or a laser disk; a magnetic storage device such as a tape, a hard disk, Storage Area Network (SAN), a Network Attached Storage (NAS), or others; a semiconductor storage device such as Flash device, memory stick, or the like. The storage can be common or separate for different types of captured segments and different types of additional data. The storage can be located onsite where the segments or some of them are captured, or in a remote location. The capturing or the storage components can serve one or more sites of a multi-site organization. A part of, or storage additional to storage 134 is storage 135 which stores the definition of the categories to which the interactions should be classified, or any other parameters related to executing any processing on captured data. Storage 134 can comprise a single storage device or a combination of multiple devices. Optionally, a preprocessing component, which invokes processing such as noise reduction, speaker separation or others is activated on the captured or logged interactions. Categories definition component 141 is used by a person in charge of defining the categories to which the interactions should be classified. The category definition includes both the category hierarchy, and the criteria to be met by each interaction in order for the interaction to be classified to that category. The criteria can be defined in two ways: 1. Manual definition based on the user's relevant experience and knowledge; or alternatively 2. Model based categorization in which the system learns from samples and produces the criteria automatically. For example, the system can receive a categorization and interactions assigned to categories, and deduce how to further assign interactions to the categories, by methods including for example neural networks. The criteria may include any condition to be met by the interaction or additional data, such as a predetermined called number, number of transfers or the like. The criteria may further include any product of processing the interactions, such as words spotted in a vocal interaction, emotional level exceeding a predetermined threshold on a vocal interaction, occurrence of one or more words in a textual interaction, or the like. The system further comprises categorization component 138, for classifying the captured or logged interactions into the categories defined using category definition component 141. The engines activated by categorization component 138 preferably comprise fast and efficient algorithms, since a significant part of the captured interactions are preferably classified. The engines activated by categorization component 138 may include, for example a text search engine, a word spotting engines a phonetic search engine, an emotion detection engine, a call flow analysis engine, a talk analysis engine, and other tools for efficient retrieval or extraction of data from interactions. The extraction engines activated by categorization component 138 may further comprise engines for retrieving data from video, such as face recognition, motion analysis or others. The classified interactions are transferred to additional processing component 142. Additional processing component 142 activates additional engines to those activated by initial processing component 138. The additional engines are preferably activated only on interactions classified to one or more categories, such as “unhappy customer”, categories related to new products, or the like. The additional engines are optionally more time- or resource-consuming than the initial engines, and are therefore activated only on some of the interactions. The results of categorization component 138 and additional processing component 142 are transferred to modeling and analysis component 144, which possibly comprises a third party analysis engine such as Enterprise Miner™ by SAS (www.sas.com). Modeling and analysis component 144 analyze the results by employing techniques such as clustering, data mining, text mining, root cause analysis, link analysis, contextual analysis, OLAP cube analysis, pattern recognition, hidden pattern recognition, one or more prediction algorithms, and others, in order to find trends, problems and other characteristics common to interactions in a certain category. The results of modeling and analysis engine 144 are preferably stored in storage 135. The results of modeling and analysis engine 144 are preferably also sent to presentation component 146 for presentation in any way the user prefers, including for example various graphic representations, textual presentation, table presentation, a presentation using a third party tool or portal, or the like. The results can further be transferred to and analyzed by a quality monitoring component 148, for monitoring one or more quality parameters of a participant in an interaction, a product, line of products, or the like. The results are optionally transferred also to s additional usage components 150, if required. Such components may include playback components, report generation components, alert generation components, or others. The analysis performed by modeling and analysis component 144 preferably reveals significant business aspects, insights, terms or events in the segments, which can be fed back into category definition component 141 and be considered in future classification sessions performed using the categories and associated criteria.

All components of the system, including capturing/logging components 132, the engines activated by categorization component 138 additional processing component 142, modeling and analysis component 144 and presentation component 146 are preferably collections of instruction codes designed to be executed by one or more computing platforms, such as a personal computer, a mainframe computer, or any other type of computing platform that is provisioned with a memory device (not shown), a CPU or microprocessor device, and several I/O ports (not shown). Alternatively, each component can be implemented as firmware ported for a specific processor such as digital signal processor (DSP) or microcontrollers, or can be implemented as hardware or configurable hardware such as field programmable gate array (FPGA) or application specific integrated circuit (ASIC). Each component can further include a storage device (not shown), storing the relevant applications and data required for processing. Each software component or application executed by each computing platform, such as the capturing applications or the classification component is preferably a set of logically inter-related computer instructions, programs, modules, or other units and associated data structures that interact to perform one or more specific tasks. All applications and software components can be co-located and executed by the same one or more computing platforms, or on different platforms. In yet another alternative, the information sources and capturing platforms can be located on each site of a multi-site organization, and one or more of the processing or analysis components can be remotely located, and analyze segments captured at one or more sites and store the results in a local, central, distributed or any other storage.

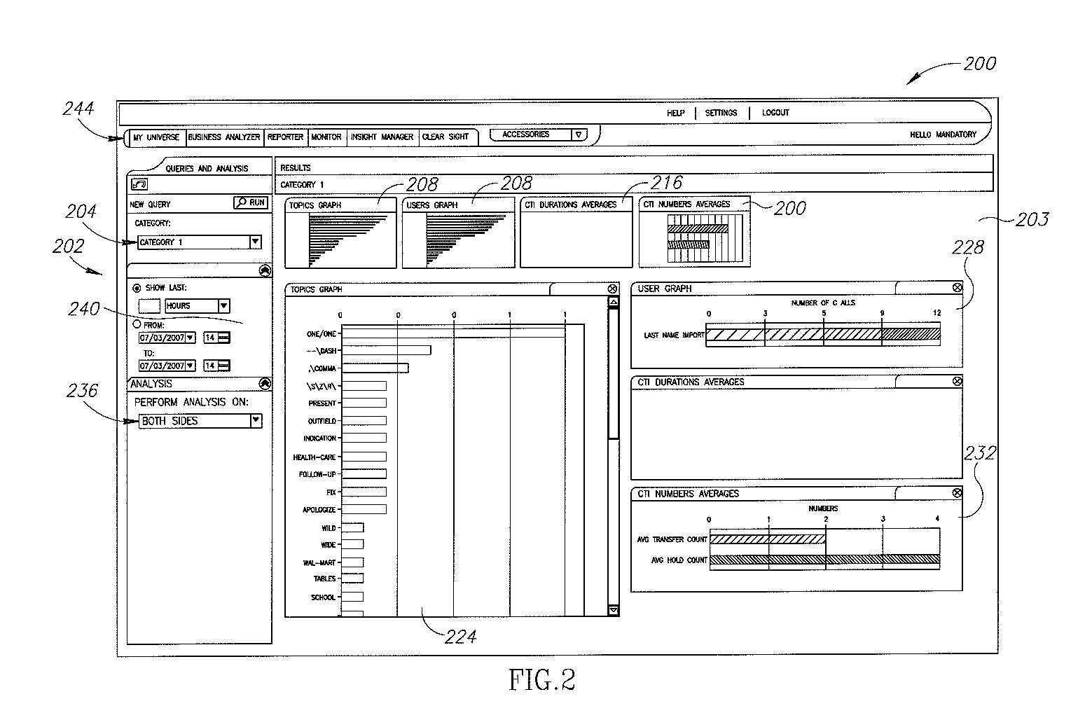

Referring now to FIG. 2, showing an exemplary screenshot displayed to a user of the disclosed method and apparatus. The screenshot, generally referenced 200 comprises user selection area 202 and display area 203. Drop-down Drop-down menu 204 of area 202 enables the user to select a category from the categories the interactions were classified to. Once a category is selected, the information related to the category is displayed on display area 203. Display area 203 shows the results of the analysis performed on all interactions categorized into category 1. In the example of FIG. 2, the information includes the topics raised in the interactions as shown in minimized manner in graph 208 and in details in graph 224. The information further includes users graph as shown in areas 212 and 228, and CTI numbers average shown in areas 220 and 232.

The user can further select to see only the results associated with specific interactions, such as the interactions captured in a specific time frame as shown in area 240, to indicate analysis parameters, such as on which sides of the interaction the analysis is to be performed, or any other filter or parameter. It will be apparent to a person skilled in the art that the types of the information shown for category 1 are determined according to the way category 1 was defined, as well as the interactions classified into category 1. Alternatively, the analysis and information types defined for category 1 can be common and defined at once for multiple categories and not specifically to category 1. Additional analysis results, if such were produced, can be seen when switching to other screens, for example by using any one or more of buttons 244 or by changing the default display parameters of the system.

It will be appreciated that the screenshot of FIG. 2 is exemplary only, and is intended to present a possible usage of the disclosed method and apparatus and not to limit their scope.

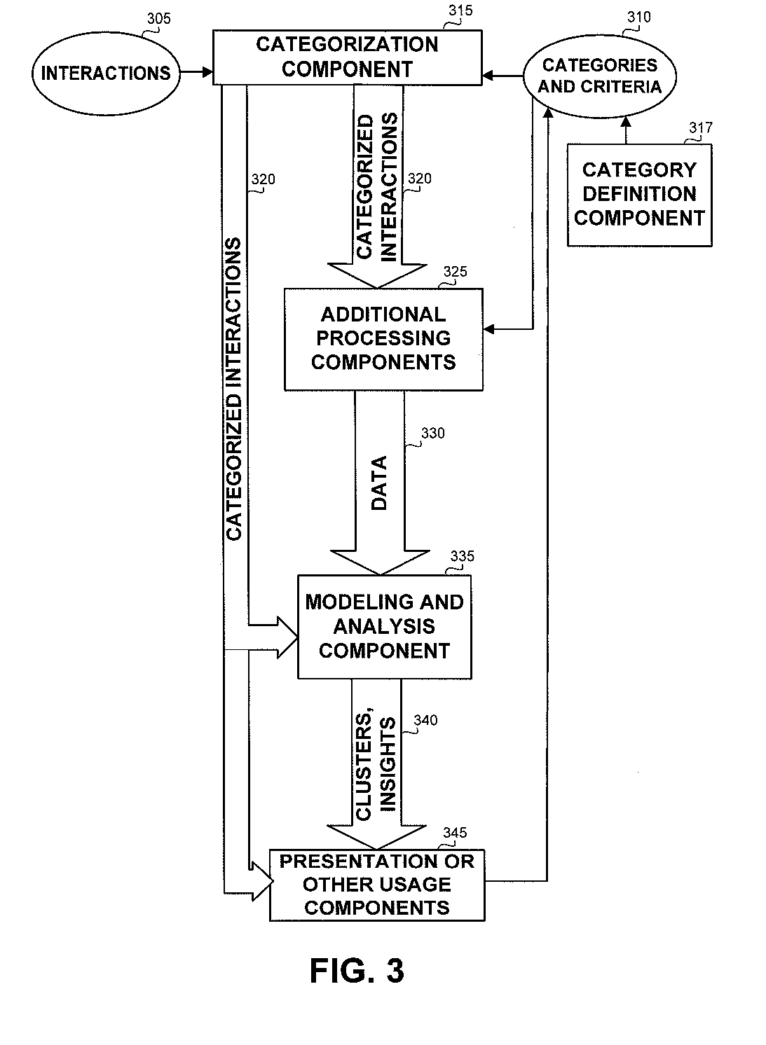

Referring now to FIG. 3, showing a block diagram of the main components in a preferred embodiment of the disclosed apparatus. The apparatus of FIG. 3 comprises categorization component 315 for classifying interactions into categories. Categorization component 315 receives interactions 305 of any type, including vocal, textual, and others, and categories and criteria 310 which define the categories and the criteria which an interaction has to comply with in order to be assigned or classified to a particular category. The criteria can involve consideration of any raw data item associated with the interaction, such as interaction length range, called number, area number called from or the like. Alternatively, the criteria can involve a product of any processing performed on the interaction, such as a word spotting, detecting emotional level or others. It will be apparent to a person skilled in the art that the criteria can be any combination, whether conditional or unconditional or two or more criteria as mentioned above. A category definition can further include whether and which additional processing the interactions assigned to the particular category should undergo, as detailed in association with component 325 below. The apparatus further comprises category definition component 317, which provides a user with tools, preferably graphic tools, textual tools, or the like, for defining one or more categories. The categories can be defined in one or more hierarchies, i.e. one or more root categories, one or more descendent categories for some of them, such that a parent category contains the descendent category, and so on, in a tree-like manner. Alternatively, the categories can be defined in a flat manner, i.e. a collection of categories none of which includes the other. The definition includes one or more criteria an interaction has to comply with in order to be associated with the category, and possibly additional processing to be performed over interactions assigned to the category. The additional analysis can be common to two or more, or even all categories, or specific to one category. Categorization component 315 examines the raw data or activates engines for assessing the more complex criteria in order to assign each interaction to one or more categories. The categorized interactions, the categories they are assigned to, and optionally additional data, such as spotted words, their location within an interaction, or the like, are transferred to additional processing component 325. Additional processing component 325 performs additional processing as optionally indicated in category definition and criteria 310. Additional processing component 325 optionally activates the same or different engines than those activated by categorization component 315. Optionally, the engines activated by additional processing component 325 have higher resource consumption relatively to the engines activated by classification component 325, since these engines are activated only on those interactions that were assigned to categories which undergo the additional processing. It will be appreciated by a person skilled in the art that the resource consumption of an engine can vary according to the parameters it is invoked with, such as the processed part of an interaction, required accuracy, allowed error rate, or the like. Thus, the same engine can be activated once by categorization component 315 and once by additional processing component 325. The products of the additional processing are transferred, optionally with the categorized interactions to modeling and analysis component 335. Modeling and analysis component 335 analyses patterns or other information in the interactions assigned to each category processed by additional processing component 325. This analysis detects and provides insight, reasoning, common characteristics or other data relevant to the categories. The analysis possibly provides the user with questions to answers associated with the category, such as “what are the reasons for customers being unhappy”, “what are the main reasons for interactions related to product A”, “which section in a suggested policy raises most questions”, and the like. Modeling and analysis component 335 employs techniques such as transcription and text analysis, data mining, text mining, text clustering, natural language processing, or the like. Component 335 can also use OLAP cube analysis, or similar tools. The insights and additional data extracted by modeling and analysis component 335 are transferred to presentation or other uses analysis components 345. Presentation component 345 can, for example, generate the screenshot shown in FIG. 2 discussed above on a display device, or any other presentation, whether textual, table-oriented, figurative or other, or any combination of the above. Presentation component 345 can further provide a user with tools for updating categories and criteria 310 according to the results of the classification and analysis engines. Thus, the products of modeling and analysis component 335 are optionally fed back into categories and criteria 310. Presentation component 345 optionally comprises a playback component for showing, playing or otherwise showing a specific interaction assigned to a particular category.

Components 315, 325, and 335 are preferably collections of computer instructions, arranged in modules, static libraries, dynamic link libraries or other components. The components are executed serially or in parallel, by one or more computing platforms, such as a general purpose computer including a personal computer, or a mainframe computer. Alternatively, the components can be implemented as firmware ported for a specific processor such as digital signal processor (DSP) or microcontrollers, or hardware or configurable hardware such as field programmable gate array (FPGA) or application specific integrated circuit (ASIC).

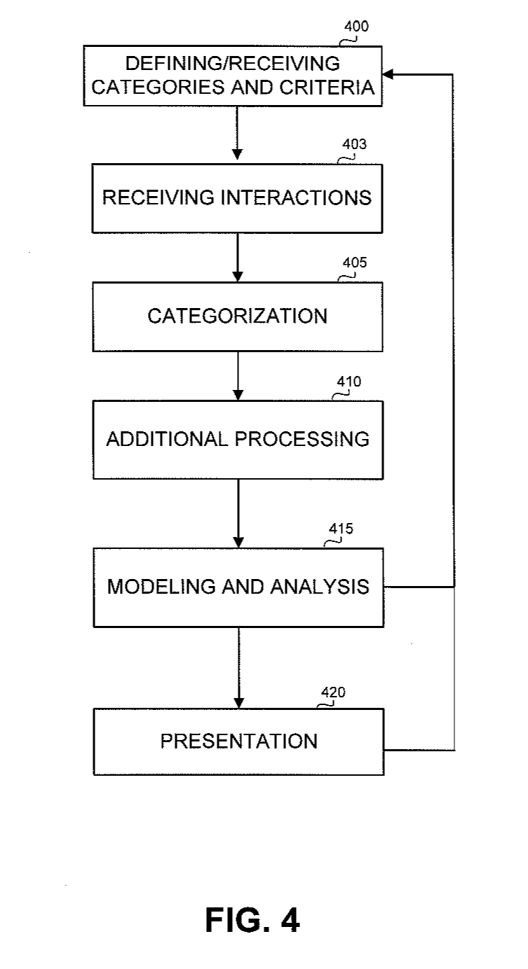

Referring now to FIG. 4, showing a flowchart of the main steps in a preferred embodiment of the disclosed method. The method starts on step 400 on which a user, such as an administrator, a person in charge of quality assurance, a supervisor, a person in charge of customer satisfaction or any other person defines categories. Alternatively, an external category definition is received or imported from another system such as a machine learning system. The category definition is preferably received or constructed in a hierarchical manner. Then, criteria to be applied to each interaction, in order to test whether the interaction should be assigned to the category are also defined or received. The criteria can relate to raw data associated with the interaction, including data received from external systems, such as CRM, billing, CTI or the like. Alternatively, the criteria relates to products of processing to be applied to the interaction, including word spotting, phonetic search, textual analysis or the like. The category definition can further include additional processing to be performed over interaction assigned to the specific category. Then on step 403 the captured or logged interactions are received for processing. Optionally, additional data, for example data external to the interaction itself such as CTI, CRM, billing or other data is also received or captured with the interactions. Optionally, the segments undergo some preprocessing, such as speaker separation, noise reduction, or the like. The segments can be captured and optionally stored and retrieved. On step 405 the interactions are classified, i.e. their compliance with the criteria relevant to each category is assessed. The classification optionally comprises activating an engine or process for detecting events within an interaction, such as terms, spotted words, emotional parts of an interaction, or events associated with the call flow, such as number of transfers, number and length of holds, silence period, talk-over periods or others, is performed on the segments. If the categories are defined as a hierarchy, then classification step 405 can be designed to first test whether an interaction is associated with a parent category before testing association with a descendent category. Alternatively, the assignment to each category can be tested independently from other categories. Classification step 405 can stop after an interaction was assigned to one category, or further test association with additional categories. If an interaction is determined to comply with criteria related to multiple categories, it can be assigned to one or more of the categories. An adherence factor or a compliance factor can be assigned to the interaction-category relationship, such that the interaction is assigned to all categories for which the adherence factor for the interaction-category relationship exceeds a predetermined threshold, to the category for which the factor is highest, or the like. The adherence factor can be determined in the same manner for all categories, or in a different way for each category. The output of step 405, being the classified interactions is transferred to additional processing step 410, in which additional processing is performed over the interactions assigned to one or more categories. The additional processing can include activating engines such as speech-to-text, i.e. full transcription additional word spotting or any other engine such as Enterprise Miner™ manufactured by SAS (www.sas.com). The output of the additional processing, such as the full texts of the interactions or parts thereof, together with the classification are processed by modeling and analysis engine on step 415, to reveal at least one aspect related to the category. Optionally, the products of modeling and analysis step 425 are fed back to category and criteria definition step 400. On step 420 the results of the analysis are presented to a user in a manner that enables the user to grasp the results of the analysis such as text clustering results within each category, topic graph, distribution of events such as transfer, or the like. The presentation optionally represent demonstrates to a user business, administrative, organizational, financial or other aspects, insights, or needs which are important for the user and relate to a certain category. The presentation can take multiple forms, including graphic presentations, text files or others. The presentation can also include or connect to additional options, such as playback, reports, quality monitoring systems, or others. Optionally, on step 420 a is user is presented with options to modify, add, delete, enhance, or otherwise change the category definition and criteria according to the presented results.

The disclosed method and apparatus provide a user with a systematic way of discovering important business aspects and insights relevant to interactions classified to one or more categories. The method and apparatus enable processing of a large amount of interactions, by performing the more resource-consuming processes only on a part of the interactions, rather than on all of them.

It will be appreciated by a person skilled in the art that the disclosed method and apparatus can be activated on a gathered corpus of interactions every predetermined period of time, once a sufficiently large corpus is collected, or once a certain threshold, peak or trend is detected, or according to any other criteria. Alternatively, the classification and additional processing can be performed in a continuous manner on every captured interaction, while modeling and analysis step 415 can be performed more seldom.

The method and apparatus can be performed over a corpus of interactions gathered over a long period of time, even if earlier collected interactions have already been processed in the past. Alternatively, the process can be performed periodically for newly gathered interactions only, thus ignoring past interactions and information deduced thereof.

It will be appreciated by a person skilled in the art that many alternatives and embodiments exist to the disclosed method and apparatus. For example, an additional preprocessing engines and steps can be used by the disclosed apparatus and method for enhancing the audio segments so that better results are achieved.

While preferred embodiments of the disclosed subject matter have been described, so as to enable one of skill in the art to practice the disclosed subject matter. The preceding description is intended to be exemplary only and not to limit the scope of the disclosure to what has been particularly shown and described hereinabove. The scope of the disclosure should be determined by reference to the following claims.

What is claimed is:

1. A method for detecting an at least one aspect related to an organization from an at least one captured interaction, the method comprising the steps of:
receiving the at least one captured interaction;
classifying the at least one captured interaction into an at least one predefined category, according to whether the at least one interaction complies with an at least one criteria associated with the at least one predefined category;
performing additional processing on the at least one captured interaction assigned to the at least one predetermined category to extract further data; and
analyzing an at least one result of performing the additional processing or an at least one result of the classifying, to detect the at least one aspect.

2. The method of claim 1 further comprising a category definition step for defining the at least one predefined category and the at least one criteria associated with the at least one predefined category.

3. The method of claim 1 further comprising a category receiving step for receiving the at least one predefined category and the at least one criteria associated with the at least one predefined category.

4. The method of claim 1 further comprising a presentation step for presenting to a user the at least one aspect.

5. The method of claim 4 wherein the presentation step relates to presentation selected from the group consisting of: a graphic presentation; a textual presentation; a table-like presentation; a presentation using a third party tool; and a presentation using a third party portal.

6. The method of claim 1 further comprising a preprocessing step for enhancing the at least one captured interaction.

7. The method of claim 1 further comprising a step of capturing or receiving additional data related to the at least one captured interaction.

8. The method of claim 7 wherein the additional data is selected from the group consisting of. Computer Telephony Integration data; Customer Relationship Management data; billing data; screen event; a web session event; a document; and demographic data.

9. The method of claim 1 wherein the categorization or the additional processing steps include activating at least one engine from the group consisting of: word spotting engine; phonetic search engine; transcription engine; emotion analysis engine; call flow analysis engine; web flow analysis engine; and textual analysis engine.

10. The method of claim 1 wherein the analyzing step includes activating at least one engine from the group consisting of: data mining; text mining; root cause analysis; link analysis; contextual analysis; text clustering, pattern recognition; hidden pattern recognition; a prediction algorithm; and OLAP cube analysis.

11. The method of claim 1 wherein the at least one interaction is selected from the group consisting of: a phone conversation; a voice over IP conversation; a message; a walk-in center recording; a microphone recording; an audio part of a video recording; an e-mail message; a chat session; a captured web session; a captured screen activity session; and a text file.

12. The method of claim 1 wherein the at least one predefined category is a part of a hierarchical category structure.

13. The method of claim 1 wherein the at least one criteria relates to the at least one captured interaction.

14. The method of claim 1 wherein the at least one criteria relates to the additional data.

15. A computing platform for detecting an at least one aspect related to an organization from at least one captured interaction, the computing platform executing:
a categorization component for classifying the at least one captured interaction into an at least one predefined category, according to whether the at least one interaction complies with an at least one criteria associated with the at least one predefined category;
an additional processing component for performing additional processing on the at least one captured interaction assigned to the at least one predetermined category to extract further data; and
a modeling and analysis component for analyzing the farther data or an at least one result produced by the classification component, to detect the at least one aspect.

16. The computing platform of claim 15 further comprising a category definition component for defining the at least one predefined category and the at least one criteria associated with the at least one predefined category.

17. The computing platform of claim 15 further comprising a presentation component for presenting the at least one aspect.

18. The computing platform of claim 17 wherein the presentation component enables to present the at least one aspect in a manner selected from the group consisting of: a graphic presentation; a textual presentation; a table-like presentation; and a presentation using a third party tool or portal.

19. The computing platform of claim 15 her comprising a logging or capturing component for logging or capturing the at least one captured interaction.

20. The computing platform of claim 15 further comprising a logging or capturing component for logging or capturing additional data related to the at least one captured interaction.

21. The computing platform of claim 20 wherein the additional data is selected from the group consisting of: Computer Telephony Integration data; Customer Relationship Management data; billing data; screen event; a web session event; a document; and demographic data.

22. The computing platform of claim 15 wherein the categorization component or the additional processing component include activating at least one engine from the group consisting of: word spotting engine; phonetic search engine; transcription engine; emotion analysis engine; call flow analysis engine; web flow analysis engine; and textual analysis engine.

23. The computing platform of claim 15 wherein the modeling and analysis component activates at least one engine from the group consisting of: data mining; text mining; root cause analysis; link analysis; contextual analysis; text clustering, pattern recognition; hidden pattern recognition; a prediction algorithm; and OLAP cube analysis.

24. The computing platform of claim 15 wherein the at least one captured interaction is selected from the group consisting of: a phone conversation; a voice over IP conversation; a message; a walk-in center recording; a microphone recording; an audio part of a video recording; an e-mail message; a chat session; a captured web session; a captured screen activity session; and a text file.

25. The computing platform of claim 15 further comprising a storage device for storing the at least one predefined category, the at least one criteria, or the categorization.

26. The computing platform of claim 15 further comprising a quality monitoring component for monitoring an at least one quality parameter associated with the at least one captured interaction.
